(19) United States
(12) Patent Application Publication
(10) Pub. No.: US 2005/0167043 A1
(43) Pub. Date: Aug. 4, 2005

(54) Formation of photopatterned ink jet nozzle modules using photopatternable nozzle-forming bonding layer

(75) Inventors: Nancy C. Stoffel, Rochester, NY (US); Almon P. Fisher, Rochester, NY (US)

Correspondence Address: Geza C. Ziegler, Jr.;Perman & Green, LLP, 425 Post Road Floor 2, Fairfield, CT, 06824, US

(73) Assignee: Xerox Corporation

(21) Appl. No.: 10/770,277

(22) Filed: Feb. 2, 2004

(51) Int. Cl. B32B 31/00

(52) U.S. Cl. 156/292; 216/27

(57) ABSTRACT

Disclosed is a process for forming fluidic ink passageways in actuation wafers for novel thermal ink jet printheads. The process comprises the steps of applying a thin coating of a heat-curable, photopatternable epoxy polymer composition to a lower substrate such as a heater wafer, and drying and photopatterning the coating to form a patterned, semi-solid adhesive layer. The layer and supporting substrate are pressed against the surface of a mating ink inlet substrate to bond the layer to the surface of the mating substrate without the need for a separate bonding layer. The present process simplifies and improves the prior known process by replacing the use of a photosensitive resin layer and a separate adhesive bonding layer with a single layer of an epoxy resin composition which is both photosensitive and adhesive, to eliminate the need for applying two separate layers and the concern that said layers have good bonding strength for their wafers and for each other.

### BACKGROUND OF THE INVENTION

1. Field of the Invention

This invention relates to ink jet printing devices and more particularly to a thermal ink jet printhead having an array of coplanar fluidic passageways that are formed from a photopatterned polymeric epoxy material which is used both for forming features and also as a structural bonding agent, together with a method of fabrication thereof.

Thermal ink jet printing is a type of drop-on-demand ink jet system wherein an ink jet printhead expels ink droplets on demand by the selective application of a current pulse to a thermal energy generator, usually a resistor, located in capillary-filled parallel ink channels a predetermined distance upstream from the channel nozzles or orifices. The channels' ends opposite the nozzles are in communication with an ink reservoir to which an external ink supply is connected. The current pulses momentarily vaporize the ink and form bubbles on demand. Each temporary bubble expels an ink droplet and propels it towards a recording medium. The printing system may be incorporated in either a carriage-type printer or pagewidth type printer. A carriage-type printer generally has a relatively small printhead containing the ink channels and nozzles. The printhead is usually sealingly attached to a disposable ink supply cartridge in a combined printhead and cartridge assembly which is reciprocated to print one swath of information at a time on a stationarily held recording medium such as paper. After the swath is printed, the paper is stepped a distance equal to the height of the printed swath so that the next printed swath will be contiguous therewith. The procedure is repeated until the entire page is printed. In contrast, the pagewidth printer has a stationary printhead having a length equal to or greater than the width of the paper. The paper is continually moved past the printhead in a direction normal to the printhead length and at a constant speed during the printing process.

U.S. Pat. No. Re. 32,572 to Hawkins et al discloses a thermal ink jet printhead and method of fabrication. In this case, a plurality of printheads may be concurrently fabricated by forming a plurality of sets of heating elements with their individual addressing electrodes on one substrate, generally a silicon wafer called the heater wafer, and etching corresponding sets of channel grooves with a common recess for each set of grooves in another silicon wafer. The wafer and substrate are aligned and bonded together with an adhesive layer so that each channel has a heating element. The individual printheads are obtained by milling away the unwanted silicon material to expose the addressing electrode terminals and then dicing the substrate to form separate printheads. This type of thermal ink jet printhead, where the direction of fluid ejection is substantially parallel to the plane of the wafer is sometimes called a sideshooter. It is such sideshooter printheads that this invention applies to.

In a second type of sideshooter printhead, the channel grooves are not etched into silicon, but are formed on the heater wafer by patterning and developing a photosensitive polymer, such as photosensitive polyimide. After curing the photosensitive polymer, the heater wafer and polymer channel structures are bonded to a second substrate which contains the ink inlet. An adhesive layer is applied on the surface of the ink inlet substrate and/or on the top surface of the polymer channels in order to bond the structure together.

Whether the channel grooves are etched in silicon or formed in photosensitive polymer, typical elements of a sideshooter printhead include a silicon heater wafer, a photosensitive polymer layer which is developed to expose the heaters and the electrical interconnection pads, an upper substrate containing the ink inlet, and an adhesive layer to bond the ink inlet substrate to the top surface of the polymer layer, so that fluidic passageways are formed. It is an object of this invention to eliminate the need for applying the layer of adhesive.

In U.S. Pat. No. 6,260,956 it has been proposed to use a polyarylene ether precursor polymer, which is photopatternable, to form the insulating layer over the heater plate, followed by photopatterning to expose the heating elements. The channel plate is prepared from the same photopatternable polymer and is then bonded to the heater plate using a thin bonding layer of the same polymer. This may be accomplished by indirect means in order to prevent the bonding layer from flowing onto the channel walls and along the apex of each channel, causing formation of a thin film along the channel walls and a bead along each apex.

According to U.S. Pat. No. 6,090,453 the photopatternable polymer is a polyarylene ether precursor polymer which is mixed with a minor amount of curable epoxy resin to provide a photosensitive layer which can be patterned on a channel plate and which has improved adhesion for the heater plate during curing of the epoxy resin.

It is an objective of the present invention to simplify the production of ink jet die modules by providing a photopatternable epoxy resin layer which can be patterned and developed on the surface of a heater wafer to provide ink channels aligned with the bubble-generating heaters, and then using the same photopatterned and developed epoxy resin layer as a bonding layer to bond the heater wafer to a corresponding ink inlet substrate and form an ink jet die module without the need to apply a separate bonding layer.

### SUMMARY OF THE INVENTION

The present invention provides a novel process for forming fluidic ink passageways in actuator wafers, such as those used for thermal ink jet or piezoelectric ink jet printheads.

According to the present invention a thermal ink jet (TIJ) die module is produced by a simplified, efficient process while also improving the quality of the module. Currently such modules are produced by coating a photosensitive layer, such as a polyimide precursor or a polyarylene ether precursor polymer layer onto a heater wafer, photopatterning the photosensitive layer and applying thereover a bonding layer such as an epoxy resin, and finally bonding the patterned heater wafer to a silicon ink inlet wafer by means of the epoxy layer.

The novel process of the present invention simplifies and improves this process by replacing the photosensitive resin layer and the adhesive bonding layer with a single layer of an epoxy resin composition which is both photosensitive and adhesive, to eliminate the need for applying two separate layers and the concern that said layers have good bonding strength for their wafers and for each other.

According to the present invention, passageways are produced by spin coating a photopatternable curable resist layer of an epoxy novolak polymer onto a heater wafer; and soft-baking the epoxy resist layer to a dry semi-solid adhesive condition.

The photoresist epoxy novolak polymer layer is then photoexposed and patterned.

### BRIEF DESCRIPTION OF THE DRAWINGS

FIG. 1 is a cross-sectional view of a TIJ die module produced according to the prior art, in which a silicon heater wafer is coated with a photopatternable layer and an adhesive bonding layer and is then bonded to an ink inlet substrate by means of the adhesive bonding layer, and

FIG. 2 is a cross-sectional view of a TIJ die module produced according to the present invention, in which a silicon heater wafer is coated with a single photopatternable epoxy bonding layer, photopatterned and then bonded to an ink inlet substrate.

### DETAILED DESCRIPTION

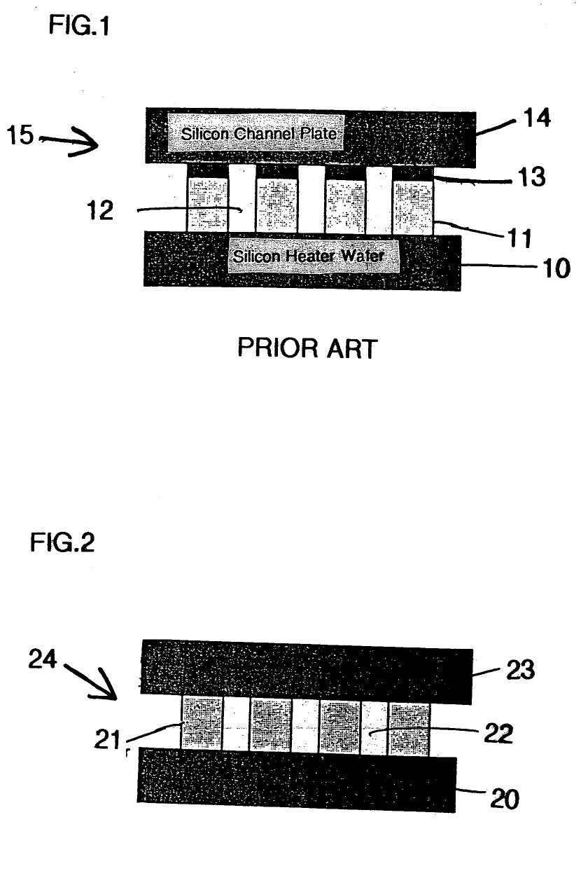

Referring to the prior art embodiment of FIG. 1, a silicon heater wafer 10 is spin-coated with a curable photopatternable layer such as a polyarylene ether precursor polymer layer or a polyimide precursor layer which is then patterned, cured, polished, surface-activated with oxygen plasma to form a photopatterned fluidic channel layer 11 containing channels 12.

Next a thin layer 13 of an adhesive, curable epoxy resin is applied or transferred over the channel layer 11 in a manner such that it does not run or spread into the channels 12, and an ink inlet substrate 14 is aligned thereover, tacked in place and laminated to cure the epoxy bonding layer and cause it to reflow and wet the mating surface of the ink inlet substrate and form a thermal ink jet die module 15. Note: optionally adhesive layer 13 may be applied to the ink inlet wafer 14 instead of, or in addition to, applying it over the channel layer 11.

Referring to the improved embodiment of the present invention, FIG. 2 illustrates a silicon heater wafer 20 spin-coated with a curable photopatternable, adhesive epoxy polymer layer which is patterned to form a fluidic channel layer 21 containing channels 22, aligned and tacked to a mating silicon channel wafer 23 to form a thermal ink jet die module 24.

The preferred photoresist solution is made by addition of about 63 parts by weight of an epoxy polymer of the formula 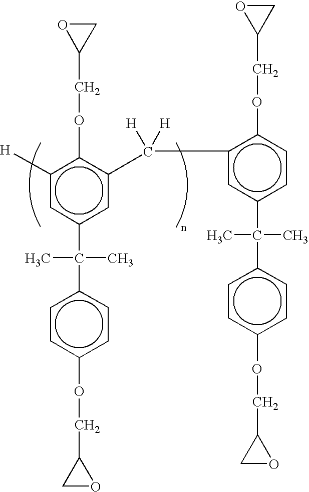
wherein n has an average value of 3 to about 20 parts by weight of γ-butyrolactone containing about 13 or 14 parts by weight triphenylsulfonium hexafluoroantimonate solution (supplied commercially as CYRACURE® UVI-6976 (obtained from Union Carbide) in a solution of 50 weight percent mixed triarylsulfonium hexafluoroantimonate in propylene carbonate). The resist-coated heater wafer 20 is covered with a negative mask and exposed to the full arc of a super-high pressure mercury bulb, amounting to from about 25 to about 500 millijoules per square centimeter as measured at 365 nanometers. The exposed wafer is then heated at from about 70 to about 95° C. for from about 10 to about 20 minutes post-exposure bake, followed by cooling to 25° C. over 5 minutes. The uncured areas of the resist coating are developed with γ-butyrolactone, washed with isopropanol, and then dried at about 70° C. for about 2 minutes to form the channel layer 21 with channels 22 shown in FIG. 2.

The present TIJ module 24 is formed by crosslinking the precursor polymer which is a phenolic novolac resin having glycidyl ether functional groups on the monomer repeat units thereof, The glycidyl ether functional groups generally are situated at the locations of the former hydrogen atoms on the phenolic hydroxy groups, Examples of suitable backbone monomers for the phenolic novolac resin include phenol, of the formula 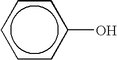
wherein the resulting glycidyl ether functionalized novolac resin includes structures of the formulae 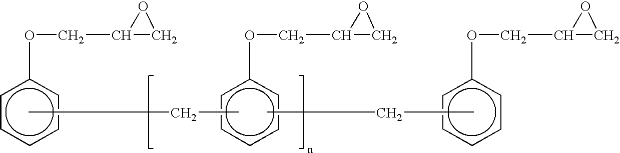
as well as branched structures thereof, o-cresol and p-cresol, of the formulae 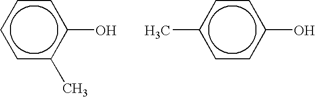
wherein the resulting glycidyl ether functionalized novolac resin includes structures of the formulae 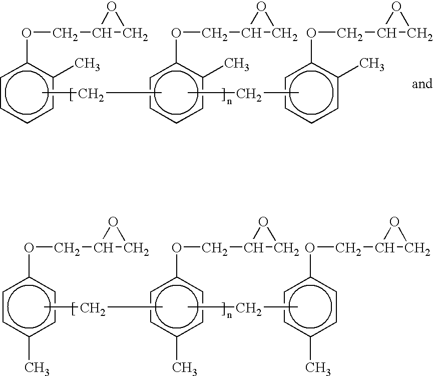
as well as branched structures thereof, bisphenol-A, of the formula 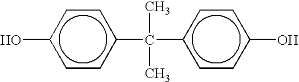
wherein the resulting glycidyl ether functionalizednovolac resin includes structures of the formulae 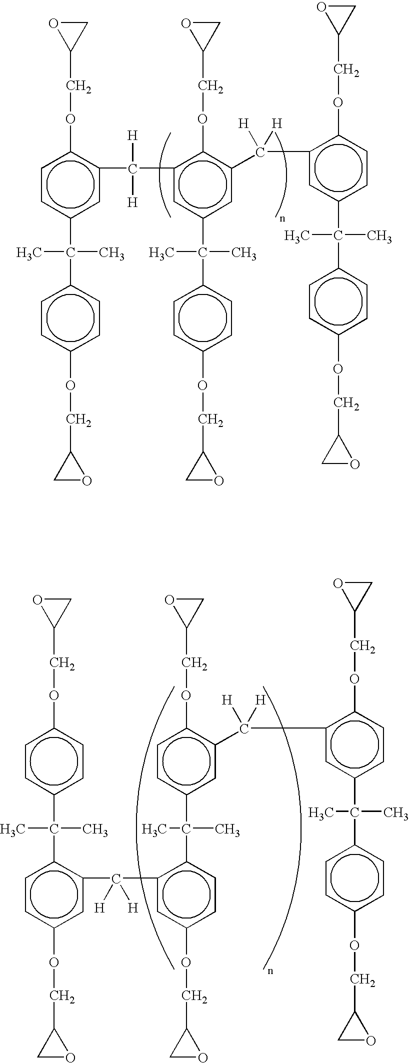
as well as randomized and branched structures thereof, and the like. The average number of repeat monomer units typically is from about 1 to about 20, and preferably is about 2, although the value of n can be outside of this range. One particularly preferred polymer is of the formula 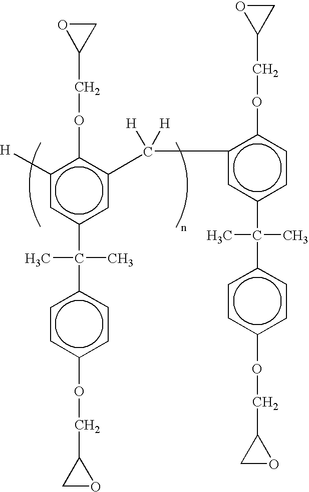
wherein n is an integer representing the average number of repeating monomer units and typically is from about 2 to about 20, and preferably is about 3, although the value of n can be outside of this range. Another particularly preferred polymer is of the formula 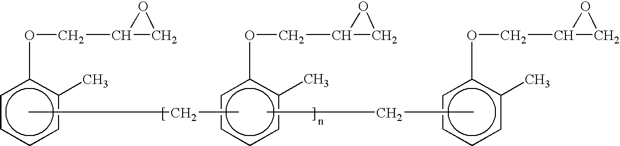
wherein n is an integer representing the average number of repeating monomer units and typically is from about 1 to about 20, and preferably is about 2, although the value of n can be outside of this range. Polymers of the formula 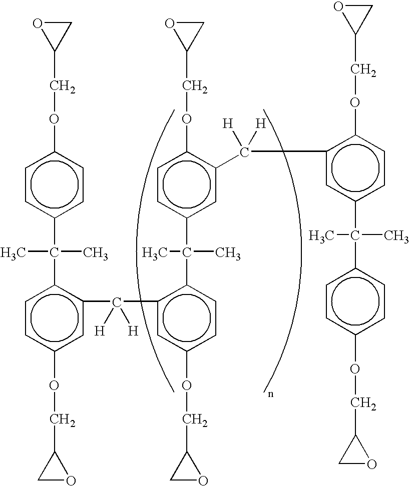
wherein n has an average value of about 3 are commercially available from, for example, Shell Resins, Shell Oil Co., Houston, Tex. as EPON® SU-8. Commercial photoresists containing this polymer, a solvent, and a cationic initiator are also available from MicroChem Corporation, Newton, Mass. and from Sotec Microsystems, Switzerland. This type of photoresist is also disclosed in, for example, U.S. Pat. Nos. 4,624,912 and 4,882,245, the disclosure of which is totally incorporated herein by reference. Polymers of the formula 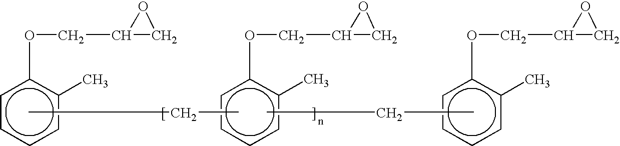
wherein n has an average value of about 3 are commercially available from, for example, Shell Resins, Shell Oil Co., Houston, Tex. as EPON® DPS-164. Suitable photoresists of the general formulae set forth hereinabove are also available from, for example, Dow Chemical Co., Midland, Mich.

The module 24 containing the patterned, adhesive, crosslinked epoxy polymer is prepared by applying to the silicon wafer 20 a photoresist layer 11 containing the uncrosslinked precursor epoxy polymer, an optional solvent for the precursor polymer, a cationic photoinitiator, and an optional sensitizer. The solvent and precursor polymer typically are present in relative amounts of from 0 to about 99 percent by weight solvent and from about 1 to 100 percent precursor polymer, preferably are present in relative amounts of from about 5 to about 60 percent by weight solvent and from about 40 to about 95 percent by weight polymer, and more preferably are present in relative amounts of from about 5 to about 40 percent by weight solvent and from about 60 to about 95 percent by weight polymer, although the relative amounts can be outside these ranges. Examples of suitable solvents include γ-butyrolactone, propylene glycol methyl ether acetate, tetrahydrofuran, methyl ethyl ketone, methyl isobutyl ketone, mixtures thereof, and the like.

Sensitizers absorb light energy and facilitate the transfer of energy to another compound, which can then form radical or ionic initiators to react to crosslink the precursor polymer. Sensitizers frequently expand the useful energy wavelength range for photoexposure, and typically are aromatic light absorbing chromophores. Sensitizers can also lead to the formation of photoinitiators, which can be free radical or ionic. When present, the optional sensitizer and the precursor polymer typically are present in relative amounts of from about 0.1 to about 20 percent by weight sensitizer and from about 80 to about 99.9 percent by weight precursor polymer, and preferably are present in relative amounts of from about 1 to about 20 percent by weight sensitizer and from about 80 to about 99 percent by weight precursor polymer, although the relative amounts can be outside these ranges.

Photoinitiators generally generate ions or free radicals which initiate polymerization upon exposure to actinic radiation. When present, the optional photoinitiator and the precursor polymer typically are present in relative amounts of from about 0.1 to about 20 percent by weight photoinitiator (in its pure form; not accounting for any solvent in which it may be commercially supplied) and from about 80 to about 99.9 percent by weight precursor polymer, and preferably are present in relative amounts of from about 1 to about 20 percent by weight photoinitiator and from about 80 to about 99 percent by weight precursor polymer, although the relative amounts can be outside these ranges.

A single material can also function as both a sensitizer and a photoinitiator.

Specific embodiments of the invention will now be described in detail. These examples are intended to be illustrative, and the invention is not limited to the materials, conditions, or process parameters set forth in these embodiments. All parts and percentages are by weight unless otherwise indicated.

### EXAMPLE I

### Resist Solution Preparation

A resist solution was prepared by mixing in a jar 33 grams of γ-butyrolactone (obtained from Aldrich Chemical Co., Milwaukee. Wis.) and 23.3 CYRACURE® UVI-6976 (containing 50 percent by weight triphenysulfonium hexafluoroantimonate in propylene carbonate, obtained from Union Carbide). Thereafter, 115 grams of EPON® SU-8 epoxy polymer of the formula 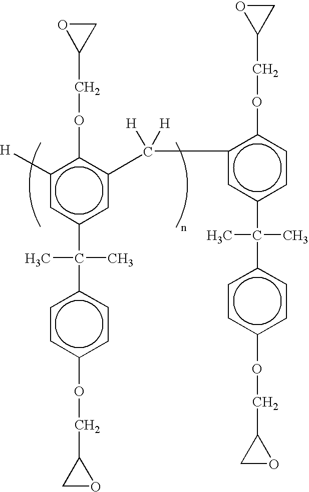
wherein n has an average value of 3 (obtained from Shell Resins) was added to the jar and the solution was mixed on a STONEWARE® roller for about one week prior to use.

A commercial resist solution of EPON SU-8 was also obtained from MicroChem Corporation Newton, Mass., and was used as received. This commercial solution is of similar composition to the one prepared as described, more specifically, accordingly to the MSDS sheet for this product, the commercial solution contained between 25 and 50 percent by weight γ-butyrolactone, between 1 and 5 percent by weight of a mixed triarylsulfonium hexafluoroantimonate salt (sulfonium(thiodi-4,1-phenylene)bis(diphenylbis((OC-6-11)hexafluoroanti monate(1-)), CAS 89452-37-9, and p-thiophenoxyphenyldlphenysulfonium hexafluoroantimonate, CAS 71449-78-0) in propylene carbonate, and between 50 and 75 percent by weight of the epoxy resin.

### Transfer Substrate Preparation

A thin silicon heater wafer 24 has applied thereto 3 to 4 grams of the resist solution followed by spin coating on a Headway Research. Inc. PWM 101 spin coater at 2000 to 4000 rpm for 20 seconds. The resulting film coating was soft baked in a circulating air oven at 70° for 20 minutes.

### Photoexposure and Processing

The wafers 20 containing the soft-baked resist films laminated thereon were exposed through a chromium mask to the actinic radiation of an exposure aligner unit until the required does had been delivered to the film. Exposure was effected with two different tools: (a) a CANON®PLA-501FA unit with a 250 Watt Ushio super-high pressure mercury lamp (model 250D) as the light source; (b) a KARL SUSS® MA 150 unit with a 350 Watt Ushio super high pressure mercury lamp (model 350DS) as the light source. The light intensity was about 6 to 10 milliwatts per square centimeter for each unit measured at 365 nonometers. Both exposure stations were operated on contact printing mode and the light intensity was measured at 365 nanometers. Light intensity for exposure with the CANON®PLA-501FA unit was performed using a UVP model UVX digital radiometer: the KARL SUSS® MA 150 unit had a built-n internal radiometer. All wafers were subjected to a post-exposure bake for 15 to 20 minutes at 70 to 90° C. in a circulating air oven directly after exposure. Subsequent to the post-exposure bake, the latent images were exposed to development with γbutyrolactone (obtained from Aldrich Chemical Co.), followed by rinsing with isopropanol.

### Lamination

Ink inlet wafers 23, the top levels of which contained oxide or bare silicon were cleaned in a bath containing 75 percent by weight sulfuric acid and 25 percent by weight hydrogen peroxide at a temperature of 120° C. The wafers were heated on a hot plate at 70° C. for 2 minutes prior to lamination to the soft baked adhesive patterned photoresist layer 21 on the silicon heater wafer 20. After aligning an ink inlet wafer 23 to a heater wafer 20, the two wafers were laminated under compression at 30 psi at a temperature of 170° C. for a time of 60 minutes in a vacuum laminator. The formed thermal ink jet module 24 has the opposed wafers 20 and 23 bonded to each other by the single adhesive photopatterned layer 21, without the need for a separate adhesive bonding layer.

Other embodiments and modifications of the present invention may occur to those of ordinary skill in the art subsequent to a review of the information presented herein; these embodiments and modifications, as well as equivalents thereof, are also included within the scope of this invention.

1. Process for forming a bonded pair of substrates comprising the steps of applying a thin coating of a heat-curable, photopatternable epoxy polymer composition to a lower substrate; drying said coating to form a semi-solid adhesive layer; photoexposing said semi-solid adhesive layer, through a mask and developing passageways therethrough, to form a patterned adhesive epoxy layer; pressing said patterned adhesive layer and supporting lower substrate against the surface of an upper substrate to bond said adhesive layer to said substrates and form a bonded pair of substrates.

2. Process of claim 1 wherein one of the two substrates is a microelectronic wafer containing multiple die sites, each die of which contains electronic circuitry.

3. Process of claim 2 wherein the bonded pair of substrates is subsequently singulated into individual microfluidic devices.

4. Process of claim 3 in which the microfluidic device is a die module for a thermal ink jet printhead.
